(19) United States
(12) Patent Application Publication
(10) Pub. No.: US 2006/0282589 A1
(43) Pub. Date: Dec. 14, 2006

(54) System and method of processing system management interrupts (SMI) in a multi-processor environment

(75) Inventors: Charles M. Ueltschey III, Austin, TX (US); Ricardo L. Martinez, Austin, TX (US)

Correspondence Address: BAKER BOTTS, LLP, 910 LOUISIANA, HOUSTON, TX, 77002-4995, US

(73) Assignee: Dell Products L.P., Round Rock, TX (US)

(21) Appl. No.: 11/148,035

(22) Filed: Jun. 8, 2005

(51) Int. Cl. G06F 13/24

(52) U.S. Cl. 710/260

(57) ABSTRACT

A method for processing a system management interrupt (SMI) in a multi-processor information handling system including a boot processor and one or more application processors is provided. An SMI is generated by a particular application processor. A swap function is initiated, causing save state data associated with the particular application processor to be communicated to a boot processor SMI handler associated with the boot processor. The boot processor executes the boot processor SMI handler to process the SMI, the boot processor SMI handler using at least the save state data communicated to the boot processor by the swap function to process the SMI.

### TECHNICAL FIELD

The present disclosure relates generally to information handling systems and, more particularly, to a system and method of processing system management interrupts (SMIs) in a multi-processor environment.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems, including computer systems, typically include multiprocessor computer systems, wherein two or more processors may be coupled to a processor bus. For example, an information handling system may include a bootstrap or boot processor (BP) and one or more other processors, which may be referred to as application processors (AP).

During the operation of an information handling system, one of the processors—either the boot processor or one of the application processors—may generate (or initiate) a system management interrupt (SMI), which is a signal from an event or program that causes the system to suspend the program execution to service the interrupt. In response the generation of the SMI, the boot processor and the application processors enter into a system management mode (SMM) in order to process the SMI. After the SMI is processed, the processors may return to their normal operation.

Although any processor may generate an SMI, typically only the boot processor actually processes the SMI, by executing an SMI handler containing a set of SMI code. Thus, when a program or application wishes to generate an SMI (such as a software SMI, for example), the program or application must ensure that it is executing on the boot processor at that time, particularly because the SMI code assumes such.

In addition, when the system enters system management mode (SMM), the boot processor saves it's current state information, or “context,” in a save state memory location associated with a boot processor SMI handler. During the processing of the SMI, the SMI code often needs to retrieve data from and/or write data to the boot processor's save state memory location. In order to exchange such data, the system much include additional code for determining the architecture of the particular boot processor executing the software, such as to account for a processor running in enhanced mode such as an IA-32e (64-bit) enabled processor, for example.

### SUMMARY

In accordance with one embodiment of the present disclosure, a method for processing a system management interrupt (SMI) in a multi-processor information handling system including a boot processor and one or more application processors is provided. An SMI is generated by a particular application processor. A swap function is initiated, causing save state data associated with the particular application processor to be communicated to a boot processor SMI handler associated with the boot processor. The boot processor executes the boot processor SMI handler to process the SMI, the boot processor SMI handler using at least the save state data communicated to the boot processor by the swap function to process the SMI.

In accordance with another embodiment, an information handling system includes multiple processors coupled to a processor bus, the multiple processors including a boot processor and one or more application processors. The boot processor is operable to process system management interrupts (SMI) generated by any of the multiple processors. The information handling system further includes a boot processor SMI handler associated with the boot processor, and a swap function communicatively coupling the boot processor SMI handler with the application processor SMI handlers. The swap function is operable, in response to a particular application processor generating an SMI, to communicate save state data associated with the particular application processor to boot processor SMI handler such that the save state data may be used by the boot processor SMI handler to facilitate processing of the SMI.

In accordance with yet another embodiment of the present disclosure, a computer-readable medium having computer-executable instructions for processing a system management interrupt (SMI) in a multi-processor information handling system including a boot processor and one or more application processors is provided. The computer-readable medium includes instructions for determining that an SMI was generated by a particular application processor, instructions for initiating a swap function causing save state data associated with the particular application processor to be communicated to a boot processor SMI handler associated with the boot processor, and instructions for executing the boot processor SMI handler to process the SMI, the boot processor SMI handler using at least the save state data communicated to the boot processor by the swap function to process the SMI.

One technical advantage of some embodiments of the present disclosure is that SMIs generated by any processor in a multi-processor information handling system may be processed by the boot processor without requiring the boot processor to generate the SMI. An application processor may generate an SMI, such as a software SMI, which may be processed by the boot processor using save state information regarding the application processor, which may be swapped into the boot processor's SMI handler.

Another technical advantage of some embodiments of the present disclosure is the ability to streamline processor code for handling system management interrupts (SMI). Because save state data may be passed (or “swapped”) from application processors to the boot processor for processing SMIs generated by the application processors, the code to process such SMIs may be reduced or streamlined.

Yet another technical advantage of some embodiments of the present disclosure is the ability to handle save state data from processors having different architectures. Because the swap function includes the ability to transform save state data into a format understandable by the boot processor's SMI handler, application processors are able to pass save state data to the boot processor's SMI handler regardless of differences in the architectures of the relevant processors. For example, the boot processor may have an advanced architecture such as IA-32e (64-bit) enabled processor that is able to swap save state data with a 32-bit processor.

Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a block diagram illustrating a multi-processor information handling system, according to teachings of the present disclosure;

FIG. 2 is a block diagram illustrating a system for processing system management interrupts (SMI) generated by any processor of the information handling system of FIG. 1, according to certain embodiments; and

FIG. 3 is a flowchart illustrating an example method of processing an SMI using the system of FIG. 2, according to one embodiment of the disclosure.

### DETAILED DESCRIPTION

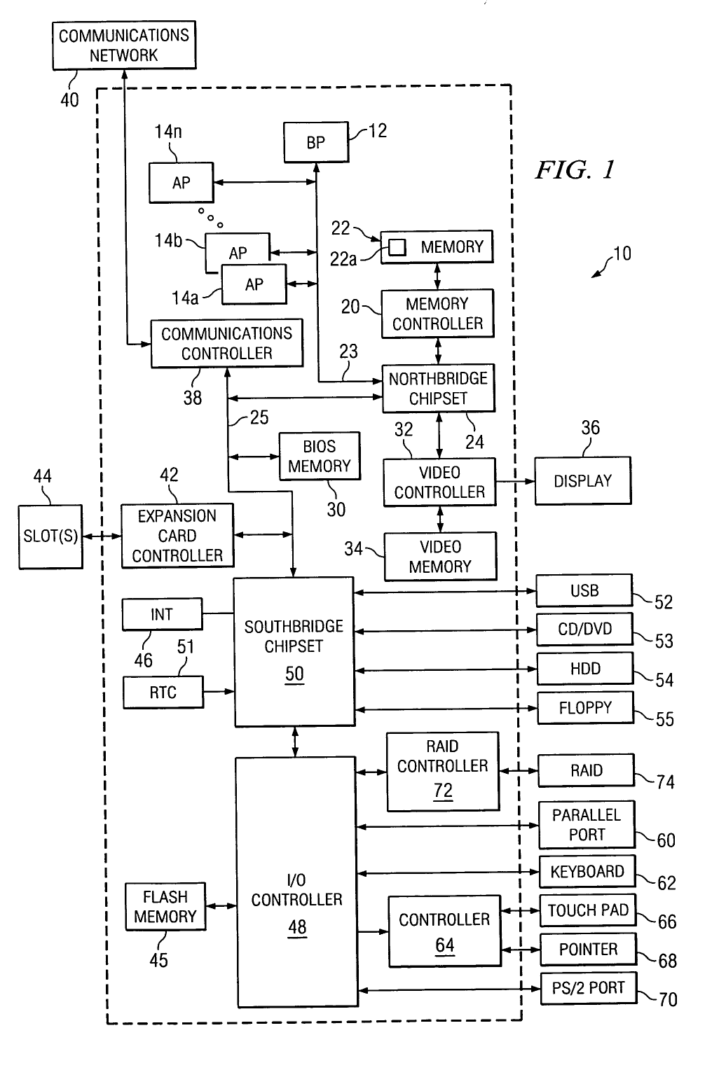

Preferred embodiments and their advantages are best understood by reference to FIGS. 1 through 3, wherein like numbers are used to indicate like and corresponding parts.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

Referring first to FIG. 1, a block diagram of a multi-processor information handling system 10 is shown, according to teachings of the present disclosure. In one example embodiment, information handling system 10 is a server. Information handling system 10 or server preferably includes one or more processors and/or microprocessors such as a bootstrap or boot processor 12 and one or more other processors, which may be referred to as application processors 14. Information handling system 10 any number of application processor(s) 14, indicated in FIG. 1 as application processors 14a-14n. Each processor 12, 14 may be coupled to a chipset, commonly referred to as Northbridge chipset 24, via a frontside bus 23.

Northbridge chipset 24 preferably couples CPU 12 to memory 22 via memory controller 20. Main memory 22 of dynamic random access memory (DRAM) modules may be divided into one or more areas such as system management mode (SMM) memory area (not expressly shown).

Graphics controller 32 is preferably coupled to Northbridge chipset 24 and to video memory 34. Video memory 34 is preferably operable to store information to be displayed on one or more display panels 36. Display panel 36 may be an active matrix or passive matrix liquid crystal display (LCD), a cathode ray tube (CRT) display or other display technology. In selected applications, uses or instances, graphics controller 32 may also be coupled to an integrated display, such as in a portable information handling system implementation (e.g., a laptop computer).

Northbridge chipset 24 serves as a “bridge” between CPU bus 23 and the connected buses. Generally, when going from one bus to another bus, a bridge is needed to provide the translation or redirection to the correct bus. Typically, each bus uses its own set of protocols or rules to define the transfer of data or information along the bus, commonly referred to as the bus architecture. To prevent communication problem from arising between buses, chipsets such as Northbridge chipset 24 and Southbridge chipset 50, are able to translate and coordinate the exchange of information between the various buses and/or devices that communicate through their respective bridge.

Basic input/output system (BIOS) memory 30 is also preferably coupled to PCI bus 25 connecting to Southbridge chipset 50. FLASH memory or other reprogrammable, nonvolatile memory may be used as BIOS memory 30. A BIOS program (not expressly shown) is typically stored in BIOS memory 30. The BIOS program preferably includes software which facilitates interaction with and between information handling system 10 devices such as a keyboard 62, a mouse such as touch pad 66 or pointer 68, or one or more I/O devices. BIOS memory 30 may also store system code (note expressly shown) operable to control a plurality of basic information handling system 10 operations.

Communication controller 38 is preferably provided and enables information handling system 10 to communicate with communication network 40, e.g., an Ethernet network. Communication network 40 may include a local area network (LAN), wide area network (WAN), Internet, Intranet, wireless broadband or the like. Communication controller 38 may be employed to form a network interface for communicating with other information handling systems (not expressly shown) coupled to communication network 40.

In certain information handling system embodiments, expansion card controller 42 may also be included and is preferably coupled to a PCI bus. Expansion card controller 42 is preferably coupled to a plurality of information handling system expansion slots 44. Expansion slots 44 may be configured to receive one or more computer components such as an expansion card (e.g., modems, fax cards, communications cards, and other input/output (I/O) devices).

Southbridge chipset 50, also called bus interface controller or expansion bus controller preferably couples PCI bus 25 to an expansion bus. In one embodiment, expansion bus may be configured as an Industry Standard Architecture (“ISA”) bus. Other buses, for example, a Peripheral Component Interconnect (“PCI”) bus, may also be used.

Interrupt request generator 46 is also preferably coupled to Southbridge chipset 50. Interrupt request generator 46 is preferably operable to issue an interrupt service request over a predetermined interrupt request line in response to receipt of a request to issue interrupt instruction from CPU 12. Such interrupts may include system management interrupts (SMI), which are signals from events or programs that cause the information handling system to suspend the program execution to service the interrupt. Example SMIs may include software SMIs and USB legacy-related SMIs. In some embodiments, any processor 12, 14 of information handling system 10 may generate, or initiate, an SMI.

Southbridge chipset 40 preferably interfaces to one or more universal serial bus (USB) ports 52, CD-ROM (compact disk-read only memory) or digital versatile disk (DVD) drive 53, an integrated drive electronics (IDE) hard drive device (HDD) 54 and/or a floppy disk drive (FDD) 55. In one example embodiment, Southbridge chipset 50 interfaces with HDD 54 via an IDE bus (not expressly shown). Other disk drive devices (not expressly shown) which may be interfaced to Southbridge chipset 50 include a removable hard drive, a zip drive, a CD-RW (compact disk-read/write) drive, and a CD-DVD (compact disk-digital versatile disk) drive.

Real-time clock (RTC) 51 may also be coupled to Southbridge chipset 50. Inclusion of RTC 51 permits timed events or alarms to be activated in the information handling system 10. Real-time clock 51 may be programmed to generate an alarm signal at a predetermined time as well as to perform other operations.

I/O controller 48, often referred to as a super I/O controller, is also preferably coupled to Southbridge chipset 50. I/O controller 48 preferably interfaces to one or more parallel port 60, keyboard 62, device controller 64 operable to drive and interface with touch pad 66 and/or pointer 68, and PS/2 Port 70. FLASH memory or other nonvolatile memory may be used with I/O controller 48.

RAID 74 may also couple with I/O controller using interface RAID controller 72. In other embodiments, RAID 74 may couple directly to the motherboard (not expressly shown) using a RAID-on-chip circuit (not expressly shown) formed on the motherboard.

Memory 22 may include storage 22a such as a local buffer that may be able to store data for one, some or all processors 12, 14 of information handling system 10. Storage 22a may include (a) a swap function (discussed below in further detail) and (b) transformation data (also discussed below in further detail).

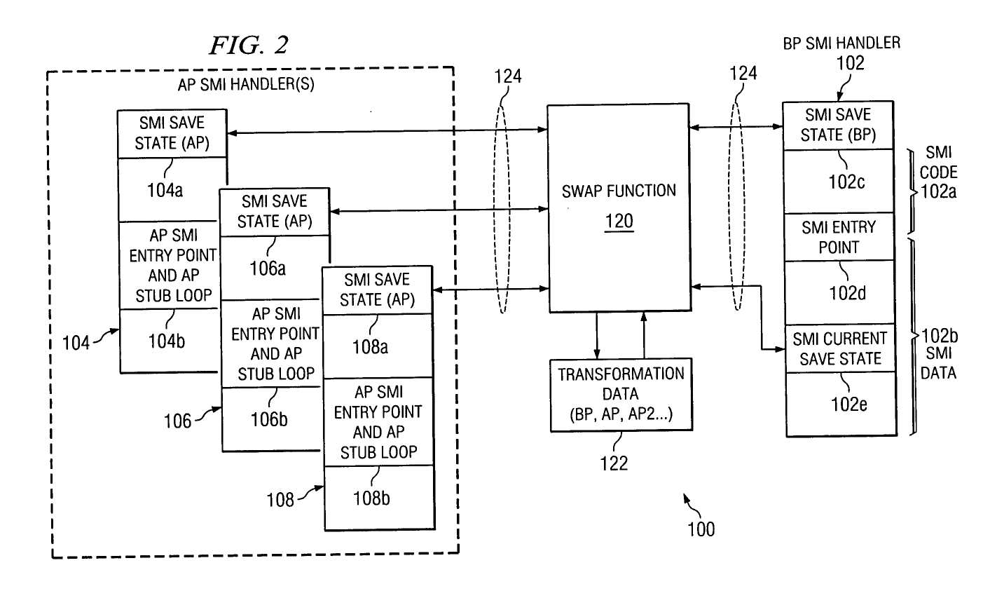

FIG. 2 is a block diagram illustrating a system 100 for processing system management interrupts (SMI) generated by any processor 12, 14 of information handling system 10, according to certain embodiments. In general, system 100 facilitates the processing of SMIs generated by any processor—including boot processor 12 or an application processor 14—by swapping save state date associated with the particular processor 12, 14 that generated the SMI into a main SMI handler that is executed by boot processor 12. (Such process may be referred to as swapping the context of the appropriate processors.) Thus, the boot main SMI handler may process any SMIs regardless of whether the SMI was generated by boot processor 12 or an application processor 14.

System 100 includes a main SMI handler 102 (which may be referred to as a boot processor (BP) SMI handler 102 because SMI handler 102 is executed by boot processor 12) and application processor (AP) SMI handlers 104, 106 and 108, each corresponding to an application processor 14. Although the illustrated example includes three AP SMI handlers 104, 106 and 108—corresponding to three application processors 14—system 100 may include any suitable number of AP SMI handlers, depending on the number of application processors 14 included in the relevant information handling system 10.

BP SMI handler 102 may include any suitable hardware and/or software suitable for processing SMIs as described herein. In this embodiment, BP SMI handler 102 includes SMI code portion 102a, SMI data portion 102b, and a BP SMI save state memory location 102c. BP SMI save state memory location 102c stores save state data (or “context data”) regarding the state of boot processor 12 upon entering into system management mode (SMM) in response to an SMI being generated by any of the processors 12, 14.

SMI code portion 102a may include code that may be executed by boot processor 12 to process SMIs. SMI data portion 102b may in include data used by SMI code portion 102a to process SMIs. SMI code portion 102a may access SMI data portion 102b via an SMI entry point 102d. SMI data portion 102b may include a current context SMI save state memory location 102e, which memory location 102e may be used to receive save state data associated with the particular processor 12, 14 that generated a particular SMI to be processed. As discussed in greater detail below, when a particular processor 12, 14 generates an SMI, save state data associated with that particular processor 12, 14 may be swapped from the appropriate SMI handler into memory location 102e such that SMI code portion 102a may use such save state data to facilitate the processing of the SMI.

Each AP SMI handler 104, 106, 108 may be a stub SMI handler that spins on a semaphore for the duration of the SMI processing period. As discussed above, the BP SMI handler may perform all of the SMI processing, regardless of the source of the SMI. Each AP SMI handler 104, 106, 108 may include an AP SMI save state memory location 104a, 106a, 108a, and a AP SMI entry point and AP stub loop portion 104b, 106b, 108b. Each AP SMI save state memory location 104a, 106a, 108a stores save state data (or “context data”) regarding the state of the corresponding application processor 14 upon entering into system management mode (SMM) in response to an SMI being generated by any of the processors 12, 14. Thus, when a processor 12, 14 generates an SMI, a first application processor 14a stores its save state data in AP SMI save state memory location 104a, a second application processor 14b stores its save state data in AP SMI save state memory location 106a, and a third application processor 14c stores its save state data in AP SMI save state memory location 108a.

As shown in FIG. 2, system 100 also includes a swap function module 120 and transformation data 122. Swap function module 120 is operable to swap save state information between current context SMI save state memory location 102e and any BP or AP save state memory location, namely BP SMI save state memory location 102c and AP SMI save state memory location 104a, 106a, 108a, as indicated by arrow 124. More particularly, when a particular processor 12, 14 generates an SMI, swap function module 120 transfers save state data associated with the particular processor 12, 14 that generated the SMI from that processor's save state memory location (102c, 104a, 106a, or 108a) into current context SMI save state memory location 102e of BP SMI handler 102. In addition, swap function module 120 may substantially simultaneously transfer the data currently stored in current context SMI save state memory location 102e into the save state memory location (102c, 104a, 106a, or 108a) associated with the particular processor 12, 14. In this manner, data may be “swapped” data between current context SMI save state memory location 102e and the relevant save state memory location (102c, 104a, 106a, or 108a).

Once swap function module 120 swaps the appropriate save state data into current context SMI save state memory location 102e, boot processor 12 may execute BP SMI handler 102 to process the SMI. Such processing may include using various SMI data 102b, including the save state data received into current context SMI save state memory location 102e from the relevant save state memory location (102c, 104a, 106a, or 108a).

When the processing of the SMI is complete, swap function module 120 may swap the save state data of the particular processor 12, 14 that generated the SMI back into that processor's corresponding save state memory location (102c, 104a, 106a, or 108a). Thus, the particular processor 12, 14 (as well as the other processors) may reconvene their operations that were interrupted by the SMI.

Transformation data 122 may include one or more maps, tables or other data structures that define, for each processor 12, 14 of information handling system 10, parameters or instructions for transforming save state data being swapped into current context SMI save state memory location 102e to a particular format, structure or orientation that may be understood by SMI code 102a for processing the relevant SMI. Such transformation may be required because different types of processors 12, 14 may store their save state data into their respective save state memory location (102c, 104a, 106a, and 108a) using different formats, structures or orientations. For example, save state data for processors running in IA-32e mode may be stored (or “dumped”) in a different format than save state data for processors running in normal mode. Thus, such save state data must be transformed, or translated, into a common format understood by SMI code 102e.

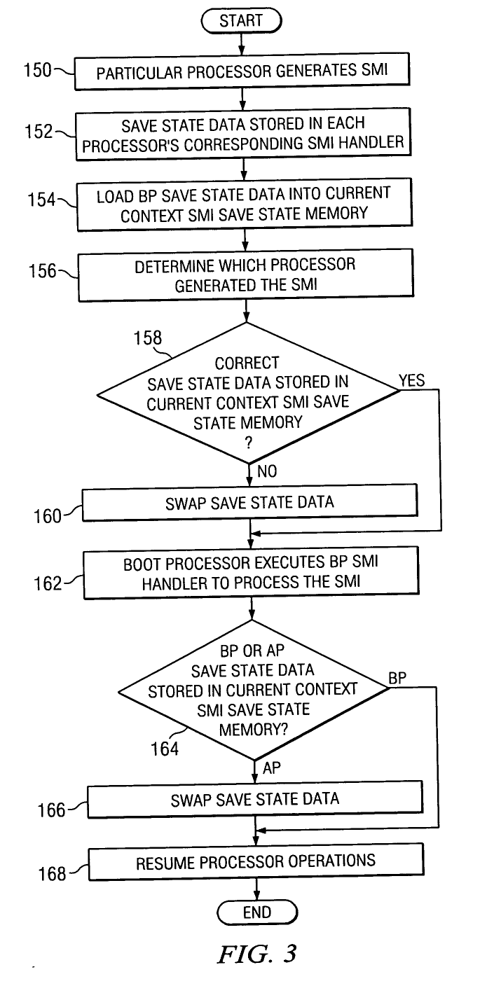

FIG. 3 is a flowchart illustrating an example method of processing an SMI using system 100 of FIG. 2, according to one embodiment of the disclosure.

At step 150, one of the processors 12, 14 of information handling system 10 generates an SMI. For example, a particular processor 12, 14 executing a particular program initiates a software SMI.

At step 152, in response to the SMI being generated, each processor 12, 14 may save its current save state data (or “context”) into the save state data memory location of that processor's corresponding SMI handler. Thus, boot processor 12 may save its BP save state data into BP save state data memory location 102c of BP SMI handler 102, and application processors 14a, 14b and 14c may save their respective AP save state data into AP save state data memory locations 104a, 106a, and 108a, respectively.

In some embodiments, the boot processor context may be loaded into current context SMI save state memory location 102e by default, prior to (or independent from) determining which processor 12, 14 actually generated the SMI. Thus, in such embodiments, at step 154, SMI handler 102 may load the BP save state data from BP save state data memory location 102c into current context SMI save state memory location 102e (or alternatively, directly from boot processor 12 into current context SMI save state memory location 102e).

In some embodiments, swap function module 120 initiates a data swap in order to load the current BP save state data into current context SMI save state memory location 102e. In addition, swap function module 120 may substantially simultaneously transfer the data currently stored in memory location 102e (i.e., BP save state data stored at step 154) into the BR save state memory location 102c. Swap function module 120 may utilize transformation data 122 for transform the data being swapped between memory location 102c and memory location 102e based on the parameters for boot processor 12 defined in transformation data 12, such as described above regarding FIG. 2.

At step 156, BP SMI handler 102 determines which processor 12, 14 actually generated the SMI. BP SMI handler 102 may make such determination in any suitable manner. For example, BP SMI handler 102 may look at the saved instruction pointer of each application processor 14 and use this location to disassemble the commands that the application processor 14 that generated the SMI was running immediately prior to generating the SMI. However, BP SMI handler 102 may use any other suitable technique(s).

At step 158, system 100 determines whether the correct save state data (i.e. context) for processing the SMI is stored in current context SMI save state memory location 102e. In other words, since BP save state data was loaded into memory location 102e at step 154, the correct context for processing the SMI is stored in memory location 102e only if boot processor 12 generated the SMI. If so, the method skips ahead to step 162. If not (i.e., if one of the application processors 14 generated the SMI), the method proceeds to step 160.

At step 160, swap function module 120 initiates a data swap in order to load the correct save state data for processing the SMI into current context SMI save state memory location 102e. Thus, if the SMI was generated by a particular application processor 14, swap function module 120 may transfer the save state data associated with the particular application processor 14 that generated the SMI from the particular processor's save state memory location (102c, 104a, or 106a) into current context SMI save state memory location 102e. In addition, swap function module 120 may substantially simultaneously transfer the data currently stored in memory location 102e (i.e., BP save state data stored at step 154) into the save state memory location (102c, 104a, 106a, or 108a) associated with the particular application processor 14. Swap function module 120 may utilize transformation data 122 for transform the data being swapped to and/or from memory location 102e based on the parameters for the particular application processor 14 defined in transformation data 12, such as described above regarding FIG. 2.

At step 162, boot processor 12 may execute BP SMI handler to process the SMI, which may include applying SMI code 102a to SMI data 102b, which includes either (a) the BP save state data loaded into memory location 102e at step 154 (in the event that the boot processor generated the SMI), or (b) the AP save state data swapped into memory location 102e at step 160 (in the event that one of the application processors 14 generated the SMI).

At step 164, upon the completion of the processing of the SMI, system 100 determines whether BP save state data or AP save state data is currently stored in memory location 102e. If BP save state data is currently stored in memory location 102e (i.e., if boot processor 12 generated the SMI), the method skips ahead to step 168. Alternatively, if AP save state data is currently stored in memory location 102e (i.e., if one of the application processors 14 generated the SMI), the method proceeds to step 166.

At step 166, swap function module 120 initiates another data swap to swap the save state data of the particular application processor 14 that generated the SMI from current context SMI save state memory location 102e back into that processor's corresponding AP save state memory location (102c, 104a, or 106a). Swap function module 120 may also swap the data that was swapped into the AP save state memory location (102c, 104a, or 106a) at step 162 back into memory location 102e.

At step 168, boot processor 12 and application processors 14 may reconvene their operations that were interrupted by the SMI. In other words, the system may continue performing its normal operations.

Although the disclosed embodiments have been described in detail, it should be understood that various changes, substitutions and alterations can be made to the embodiments without departing from their spirit and scope.

What is claimed is:

1. A method for processing a system management interrupt (SMI) in a multi-processor information handling system including a boot processor and one or more application processors, comprising:
determining that an SMI was generated by a particular application processor;
initiating a swap function causing save state data associated with the particular application processor to be communicated to a boot processor SMI handler associated with the boot processor; and
the boot processor executing the boot processor SMI handler to process the SMI, the boot processor SMI handler using at least the save state data communicated to the boot processor by the swap function to process the SMI.

2. The method of claim 1, further comprising:
in response to the generation of the SMI, the boot processor storing save state data in a boot processor saved state memory location associated with a boot processor SMI handler; and
in response to the generation of the SMI, each application processor storing save state data in an application processor saved state memory location associated with an application processor SMI handler associated with that application processor.

3. The method of claim 2, further comprising:
initializing a current saved state memory location associated with the boot processor SMI handler by loading save state data associated with the boot processor into the current saved state memory location; and
wherein the swap function causes the save state data associated with the particular application processor to be communicated into the current saved state memory location.

4. The method of claim 3, further comprising, upon the completion of the processing of the SMI, initiating a second swap function to return the save state data associated with the particular application processor from the current saved state memory location associated with the boot processor SMI handler to the application processor saved state memory location associated with the particular application processor.

5. The method of claim 1, further comprising transforming the save state data associated with the particular application processor being communicated to the boot processor SMI handler.

6. The method of claim 5, wherein transforming the save state data associated with the particular application processor comprises reorganizing the structure of the save state data using a transformation table, the transformation table defining parameters for transforming save state data associated with any of the multiple processors into a common structure that may be used by the boot processor SMI handler for processing SMIs generated by any of the multiple processors.

7. The method of claim 1, wherein the generated SMI comprises a software SMI.

8. An information handling system, comprising:
multiple processors coupled to a processor bus, the multiple processors including a boot processor and one or more application processors;
the boot processor operable to process system management interrupts (SMI) generated by any of the multiple processors;
a boot processor SMI handler associated with the boot processor; and
a swap function module communicatively coupling the boot processor SMI handler with the application processor SMI handlers;
the swap function module operable, in response to a particular application processor generating an SMI, to communicate save state data associated with the particular application processor to boot processor SMI handler such that the save state data may be used by the boot processor SMI handler to facilitate processing of the SMI.

9. The information handling system of claim 8, further comprising application processor SMI handlers associated with each application processor;
wherein, in response to the generation of the SMI, the boot processor stores save state data in a boot processor saved state memory location associated with the boot processor SMI handler; and
wherein, in response to the generation of the SMI, each application processor stores save state data in an application processor saved state memory location corresponding to the application processor SMI handler associated with that application processor.

10. The information handling system of claim 9, wherein the swap function module causes the save state data associated with the particular application processor to be communicated from the saved state memory location corresponding to the application processor SMI handler associated with the particular application processor to the current saved state memory location associated with the boot processor SMI handler.

11. The information handling system of claim 10, wherein the swap function module is further operable, upon the completion of processing the SMI, to return the save state data associated with the particular application processor from the current saved state memory location associated with the boot processor SMI handler to the application processor saved state memory location associated with the particular application processor.

12. The information handling system of claim 8, further comprising transformation data stored in memory, the transformation data defining parameters for transforming save state data associated with any of the multiple processors into a common structure that may be used by the boot processor SMI handler for processing SMIs generated by any of the multiple processors; and
wherein the swap function module is operable to use the transformation data to transform the structure of the save state data associated with the particular application processor before communicating the save state data to the boot processor SMI handler.

13. The information handling system of claim 8, wherein the generated SMI comprises a software SMI.

14. A computer-readable medium having computer-executable instructions for processing a system management interrupt (SMI) in a multi-processor information handling system including a boot processor and one or more application processors, comprising:
instructions for determining that an SMI was generated by a particular application processor;
instructions for initiating a swap function causing save state data associated with the particular application processor to be communicated to a boot processor SMI handler associated with the boot processor; and
instructions for executing the boot processor SMI handler to process the SMI, the boot processor SMI handler using at least the save state data communicated to the boot processor by the swap function to process the SMI.

15. The computer-readable medium of claim 14, further comprising:
instructions for storing, in response to the generation of the SMI, save state data in a boot processor saved state memory location associated with a boot processor SMI handler; and
for each application processor, instructions for storing, in response to the generation of the SMI, save state data in an application processor saved state memory location associated with an application processor SMI handler associated with that application processor.

16. The computer-readable medium of claim 15, further comprising:
instructions for initializing a current saved state memory location associated with the boot processor SMI handler by loading save state data associated with the boot processor into the current saved state memory location; and
wherein the swap function causes the save state data associated with the particular application processor to be communicated into the current saved state memory location.

17. The computer-readable medium of claim 16, further comprising instructions for initiating, upon the completion of the processing of the SMI, a second swap function to return the save state data associated with the particular application processor from the current saved state memory location associated with the boot processor SMI handler to the application processor saved state memory location associated with the particular application processor.

18. The computer-readable medium of claim 14, further comprising instructions for transforming the save state data associated with the particular application processor being communicated to the boot processor SMI handler.

19. The computer-readable medium of claim 18, wherein the instructions for transforming the save state data associated with the particular application processor comprise instructions for reorganizing the structure of the save state data using a transformation table, the transformation table defining parameters for transforming save state data associated with any of the multiple processors into a common structure that may be used by the boot processor SMI handler for processing SMIs generated by any of the multiple processors.

20. The computer-readable medium of claim 14, wherein the generated SMI comprises a software SMI.
